(19) United States
(12) Patent Application Publication
(10) Pub. No.: US 2003/0191813 A1
(43) Pub. Date: Oct. 9, 2003

(54) Virtual travel system and a method therefor

(76) Inventors: David P. Hughes, Lake Havasu, AZ (US); Christopher A. Crane, Lake Havasu, AZ (US); Kelly A. Knight, Lake Havasu, AZ (US)

Correspondence Address: WEISS & MOY PC, 4204 NORTH BROWN AVENUE, SCOTTSDALE, AZ, 85251, US

(21) Appl. No.: 10/115,854

(22) Filed: Apr. 3, 2002

(51) Int. Cl. G06F 15/16

(52) U.S. Cl. 709/217

(57) ABSTRACT

A virtual travel system has an information server. The information server is used for storing data related to a plurality of different travel destinations. A monitor is coupled to the information server for viewing the data stored on the information server. An information server access box is coupled to the monitor and to the information server for accessing the information server and for transferring the data from the information server to the monitor.

### BACKGROUND OF THE INVENTION

1. Field of the Invention

This invention relates to travel and, more specifically, to a system and method to view different travel destinations in the privacy of your home, hotel room, or any other location through the use of a television, computer, or the like which receives data through the telephone line, cable, satellite, or other devices which transmit data.

2. Description of the Prior Art

Presently, more and more people are traveling to different locations for work or pleasure. When traveling, many people have no information about the location where they are going. Many travelers have no idea on where to stay, where to eat, what sites there are to see, etc.

Because of the above problem, many travelers will go to a travel agency to make travel arrangements. At the travel agency, travelers can get different information about where to stay, eat, different sites to see, etc. The travel agency may even have brochures and/or photographs of different resorts/hotels and different sites to see.

However, a problem arises in that many people do not want to go to a travel agency. Many people don't want to take the time out of their busy schedule to go down to the local travel agency and further to spend the time talking with the travel agent. Furthermore, many travel agencies charge their clients for their services.

Therefore, a need existed to provide a system and method that will allow individuals to view different travel destinations. The system and method must allow individuals to view different travel destinations in the privacy of their home, hotel room, or any other location through the use of a television, computer, or the like which will receive data transmitted through the telephone line, cable line, satellite, or other devices which transmit data. The system and method will allow interactive viewing of different travel destinations as well as places to stay, places to eat, site seeing locations, and the like.

### SUMMARY OF THE INVENTION

In accordance with one embodiment of the present invention, it is an object of the present invention to provide a system and method that will allow individuals to view different travel destinations.

It is another object of the present invention to provide a system and method that will allow individuals to view different travel destinations in the privacy of their home, hotel room, or any other location through the use of a television, computer, or the like which will receive data transmitted through the telephone line, cable line, satellite, or other devices which transmit data.

It is still another object of the present invention to provide a system and method that will allow interactive viewing of different travel destinations as well as places to stay, places to eat, site seeing locations, and the like.

### BRIEF DESCRIPTION OF THE EMBODIMENTS

In accordance with one embodiment of the present invention a virtual travel system is disclosed. The virtual travel system comprises an information server. The information server is used for storing data related to a plurality of different travel destinations. A monitor is coupled to the information server for viewing the data stored on the information server. An information server access box is coupled to the monitor and to the information server for accessing the information server and for transferring the data from the information server to the monitor.

In accordance with another embodiment of the present invention, a virtual travel system is disclosed. The virtual travel system has an information server for storing data related to a plurality of different travel destinations. A firewall is coupled to the information server for protecting the information server from unauthorized access. A monitor is provided to view the data stored on the information server. An information server access box is coupled to the monitor and to the information server for accessing the information server and for transferring data from the information server to the monitor. Wireless transmission means are coupled to the information server and the information server access box for wirelessly transmitting the data from the information server to and from the information server access box.

In accordance with another embodiment of the present invention, a method of providing a virtual travel system comprising the steps of: programming an information server with data related to a plurality of different travel destinations; accessing the information server via an information server access box; and transferring the data from the information server to a monitor.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified block diagram of the virtual travel system of the present invention.

FIG. 2 is one embodiment of a main display page for the virtual travel system of the present invention.

FIG. 3 is one embodiment of another display page for the virtual travel system of the present invention.

FIG. 4 is one embodiment of another display page for the virtual travel system of the present invention.

FIG. 5 is one embodiment of another display page for the virtual travel system of the present invention.

FIG. 6 is another embodiment of a main display page for the virtual travel system of the present invention.

### DETAILED DESCRIPTION OF THE PREFERRED EMBODIMENT

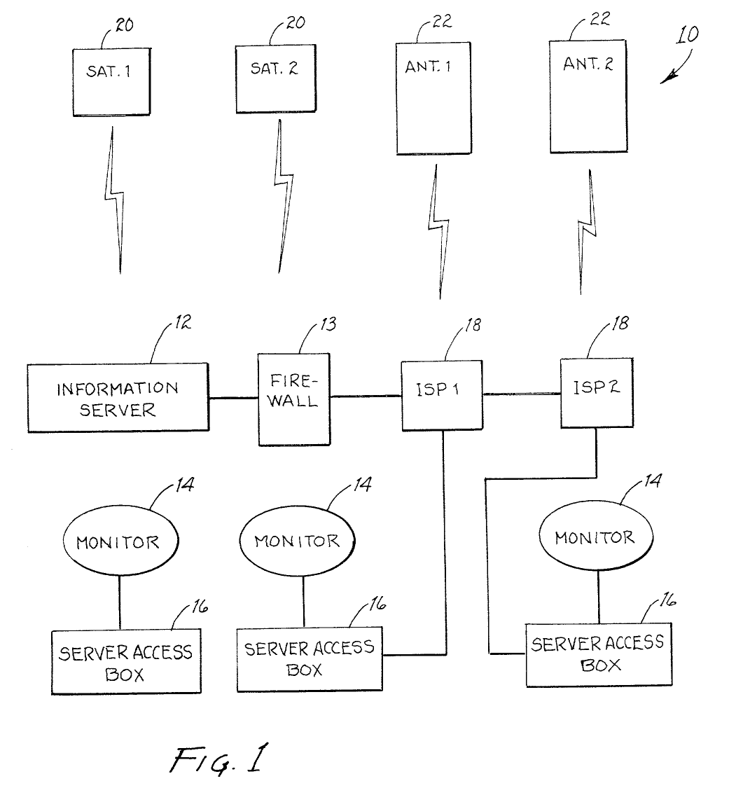

Referring now to FIG. 1, a simplified block diagram of one embodiment of the virtual travel system 10 (hereinafter system 10) is shown. The system 10 may be a hard wired system, a wireless system, or a combination of both wired and wireless. The system 10 will have one or more information servers 12. The information server 12 may be protected by a firewall 13 to prevent unauthorized personnel from accessing the information server 12. The information server 12 is programmed to store travel information about various different travel destinations. The information may include a listing of different places to stay, places to eat, different sites to see, a calendar of events for the location, recreation areas, and the like. The listing of the above is given as an example and should not be seen as to limit the scope of the present invention. Other information about a location could also be programmed into the information server 12.

The server 12 will contain audio, visual and/or textual information about each location. All of this information would be programmed in the information server 12. Audio information would be stored in different types of files such as an MP3, WAV, AU, RAM, RM, ZIP, and the like. It should be noted that the listing of the above types of audio files should not be seen as to limit the scope of the present invention. Other types of audio files may be used without departing from the spirit and scope of the present invention. The audio files would provide audio information/description about the particular location. The audio files would also provide audio details about different places to eat, sleep, sites to see, etc.

Visual information such as text and photographs would also be stored in the information server 12. Text files would be stored as ANSI, ASCII, HTML, TXT, DOC, WP, RTF, and the like. It should be noted that the listing of the above types of text files should not be seen as to limit the scope of the present invention. Other types of audio files may be used without departing from the spirit and scope of the present invention. Like the audio files, the text files would provide textural information/description about the particular location. The text files would also provide written details about different places to eat, sleep, sites to see, etc.

The photographic files would be stored as TIFF, BMP, JPG, PCX, GIF, WIF, XIF, and the like. It should be noted that the listing of the above types of graphic files should not be seen as to limit the scope of the present invention. Other types of graphic files may be used without departing from the spirit and scope of the present invention. Like the audio and text files, the graphic files would provide pictorial information/description about the particular location. The graphic files would also provide pictorial details about different places to eat, sleep, sites to see, etc.

The information server 12 would also store a plurality of different video files on each different location. The video files may be ASF, WM, WMA, WMV, AVI, MPEG, RM, VIVO, and the like. It should be noted that the listing of the above types of video files should not be seen as to limit the scope of the present invention. Other types of video files may be used without departing from the spirit and scope of the present invention. Like the audio, text, and graphic files, the video files would provide video information/description about the particular location. The video files would also provide pictorial details about different places to eat, sleep, sites to see, etc. The video files may be taped files or live video feeds from a particular location/place. The video files maybe interactive files which would allow a viewer to pan in a certain direction as well as zoom in and/or out.

In order to view the data stored in the information server 12, a monitor 14 is used. The monitor 14 may be a computer monitor, a televison, a video display, or the like. The monitor 14 may be located in the privacy of your home, hotel room, or any other location. The monitor 14 is coupled to a web access terminal 16. The web access terminal 16 will allow one to access the information server 12. The web access terminal 16 may directly access the information server 12 or the web access terminal 16 may access the information server via an Internet Service Provider (ISP) 18. The web access terminal 16 may access the information server 12 an/or the ISP 18 by wired or wireless means. Wired means may include telephone lines, cable lines, and the like. If a wireless means is used, data is transmitted via satellites 20, antennas 22, or like devices.

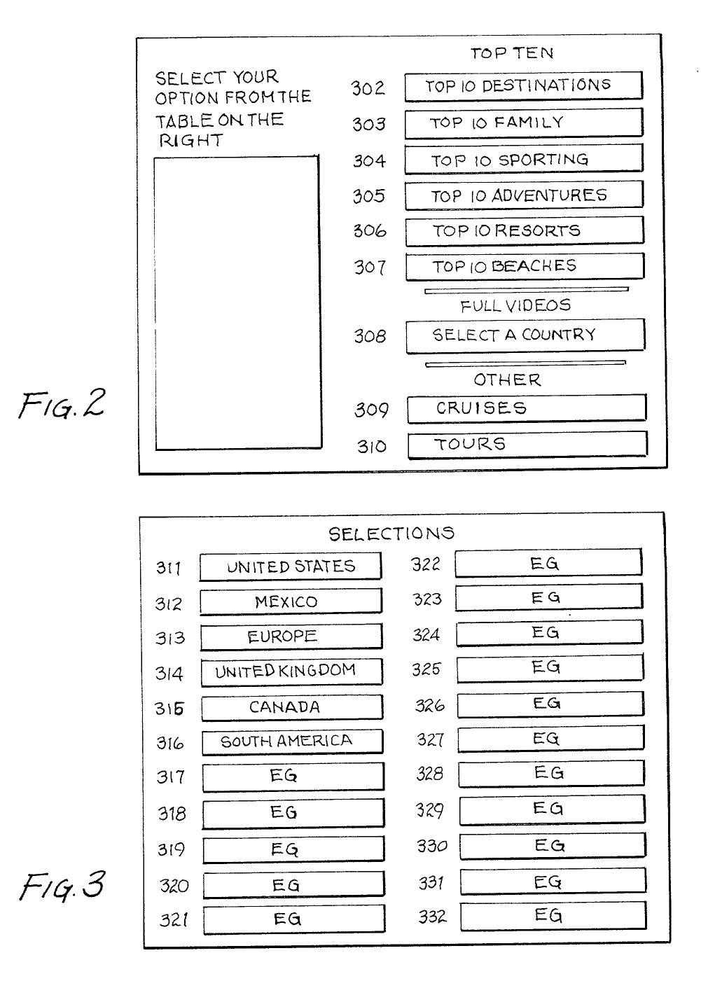

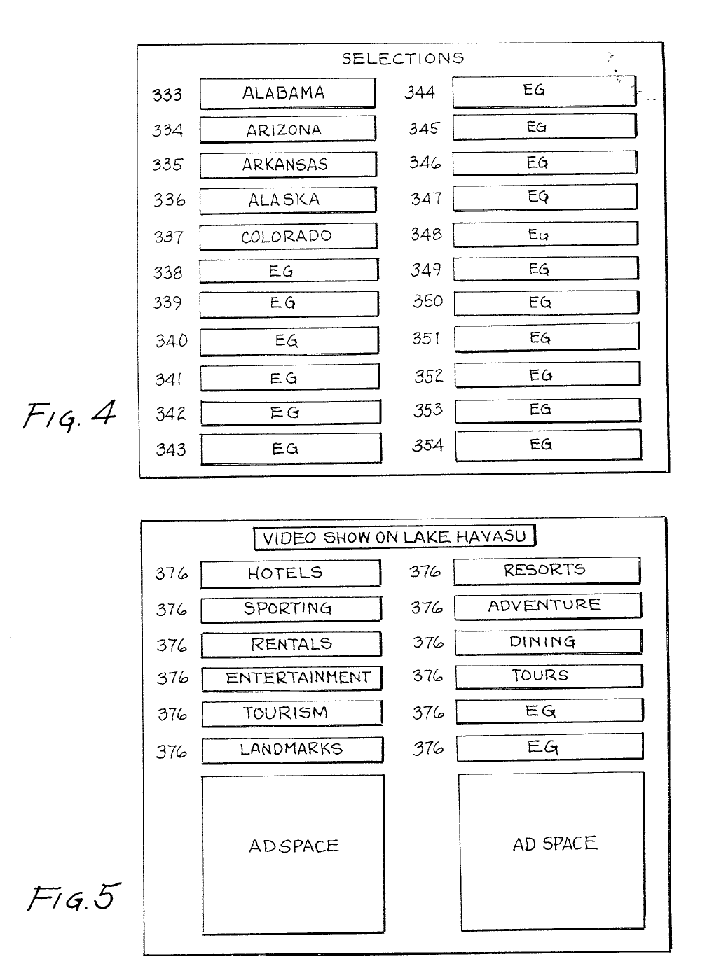

Once a user accesses the information server 12, a screen similar to that shown in FIG. 2 will appear on the monitor 14. The monitor may be a computer monitor, a television, or the like. The screen will have different travel location links or channels (hereinafter links) from which the user may select from. The links may be a link to another page or a pull down menu to a direct link to a specific location. The user may further just type in a location to directly access that particular location. When a user selects a particular link, for example “Select A Country”, the user will be transported to another web page/channel similar to that shown in FIG. 3. From here, the user may select a link of a desired country. If the user selects “United States”, the user will again be transported to another web page/channel similar to that shown in FIG. 4. Here a user may select a specific state and or city (i.e., by a pull down menu of cities in a specific state). Once a user has specified a specific location (for example Lake Havasu, Ariz.), the user will be sent to a web page/channel similar to that shown in FIG. 5.

The web page for a particular location/city will have links to different amenities, events, etc. As shown in FIG. 5, the links may include, but is not limited to, hotels, sporting events, rentals, entertainment, tourism, landmarks, resorts, adventure, dining, tours, etc. Each of these links will take the user to different pages where they may review different information on that particular category. For example, if the user selects “HOTELS”, a listing of all the different hotels in the area will be displayed. A user may select a particular hotel to view information on that hotel. The information may be in the form of text, pictures, videos, live shows, and the like. One may even be able to make reservations with the hotel via the link.

The virtual travel system 10 of the present invention will allow a viewer instant access to any vacation spot or city in the world without having to go to a local travel agent. The system 10 will allow a user to view different travel destinations in the privacy of your home, hotel room, or any other location through the use of a television, computer, or the like. The system 10 will provide detailed information in the form of text, pictures, and video of each destination. A user can access the information through the use of a keyboard or remote control device. The system 10 is designed so that a person may take a mini vacation before they take a real vacation.

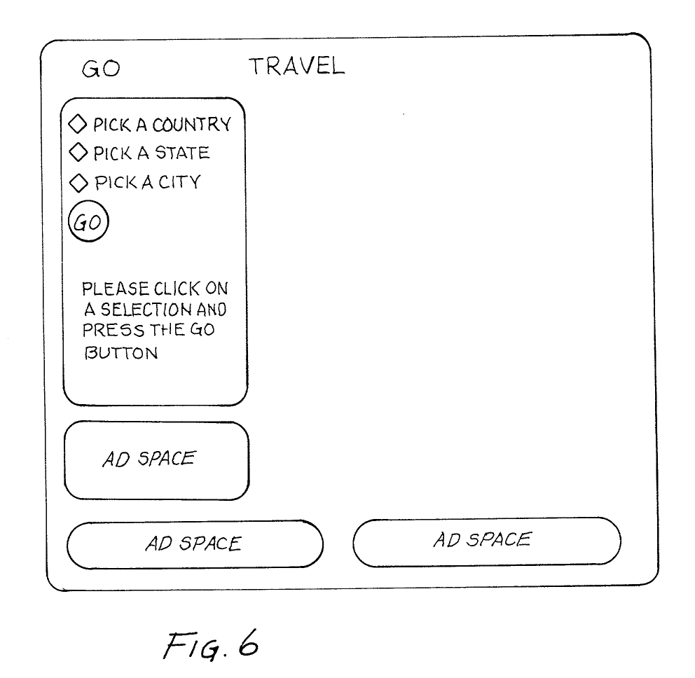

The system 10 may be set up as a subscription based system 10, pay per view, or free. If the system 10 is a free or pay service, the system 10 may charge cites, companies, ISPs, advertisers, and the like for placing their name on or using the system 10. Furthermore, the system 10 may charge companies for placing advertisements on a web page as shown in FIGS. 5 and 6.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A virtual travel system comprising, in combination:
an information server for storing data related to a plurality of different travel destinations;
a monitor to view the data stored on the information server; and
an information server access box coupled to the monitor and to the information server for accessing the information server and for transferring data from the information server to the monitor.

2. The virtual travel system in accordance with claim 1 further comprising a firewall coupled to the information server for protecting the information server from unauthorized access.

3. The virtual travel system in accordance with claim 1 further comprising at least one ISP coupled to the information server.

4. The virtual travel system in accordance with claim 1 further comprising wireless transmission means coupled to the information server and the information server access box for wirelessly transmitting the data from the information server to and from the information server access box.

5. The virtual travel system in accordance with claim 1 wherein the information server is programmed with textural and pictorial information about the plurality of different travel destinations.

6. The virtual travel system in accordance with claim 1 wherein the information server is programmed with video information about the plurality of different travel destinations.

7. The virtual travel system in accordance with claim 1 wherein the information server is programmed with live video information about the plurality of different travel destinations.

8. The virtual travel system in accordance with claim 1 wherein the information server access box allows one to control what data is displayed on the monitor.

9. A virtual travel system comprising, in combination:
an information server for storing data related to a plurality of different travel destinations;
a firewall coupled to the information server for protecting the information server from unauthorized access;
a monitor to view the data stored on the information server;
an information server access box coupled to the monitor and to the information server for accessing the information server and for transferring data from the information server to the monitor; and
wireless transmission means coupled to the information server and the information server access box for wirelessly transmitting the data from the information server to and from the information server access box.

10. The virtual travel system in accordance with claim 9 further comprising at least one ISP coupled to the information server.

11. The virtual travel system in accordance with claim 9 wherein the information server is programmed with textural and pictorial information about the plurality of different travel destinations.

12. The virtual travel system in accordance with claim 9 wherein the information server is programmed with video information about the plurality of different travel destinations.

13. The virtual travel system in accordance with claim 9 wherein the information server is programmed with live video information about the plurality of different travel destinations.

14. The virtual travel system in accordance with claim 9 wherein the information server access box allows one to control what data is displayed on the monitor.

15. A method of providing a virtual travel system comprising the steps of:
programming an information server with data related to a plurality of different travel destinations;
accessing the information server via an information server access box; and
transferring the data from the information server to a monitor.

16. The method of claim 15 further comprising providing a firewall coupled to the information server for protecting the information server from unauthorized access.

17. The method of claim 15 further comprising the step of providing at least one ISP coupled to the information server.

18. The method of claim 15 further comprising the step of providing wireless transmission means coupled to the information server and the information server access box for wirelessly transmitting the data from the information server to and from the information server access box.

19. The method of claim 15 further comprising the step of programming the information server with textural and pictorial information about the plurality of different travel destinations.

20. The method of claim 15 further comprising the step of programming the information server with video information about the plurality of different travel destinations.

21. The method of claim 15 wherein the information server transmits live video information about the plurality of different travel destinations.
